(19) United States
(12) Patent Application Publication
(10) Pub. No.: US 2025/0230734 A1
(43) Pub. Date: Jul. 17, 2025

(54) PRESSURE REGULATOR FOR POLYMER INJECTION

(71) Applicants: Fernando Antonio BLANCO MOGOLLON, Floridablanca, Santander (CO); Joanna BINNING, Garín, Buenos Aires (AR); Stefano ZANETTI, Garín, Buenos Aires (AR)

(72) Inventors: Joanna Binning, Buenos Aires (AR); Stefano Zanetti, Buenos Aires (AR)

(21) Appl. No.: 18/213,695

(22) PCT Filed: Dec. 23, 2020
(86) PCT No.: PCT/CO2020/000018

§ 371 Date: Apr. 7, 2025

(51) Int. Cl. E21B 43/12; E21B 34/06

(52) U.S. Cl. CPC E21B 43/12; E21B 34/06

(57) ABSTRACT

A pressure regulating device with low molecular decay in fluids applied to secondary recovery of oil wells, featuring a housing (8) capable of being immovably housed and retained within a pocket mandrel.

Inside the said housing (8), a rod body (18) equipped with a plurality of annular projections (26) perpendicular to the longitudinal axis of the rod (18) is housed; each pair of annular projections is separated by chosen rod portions between depressions of circular cross-section and depressions of substantially cylindrical cross-section.

Between the backs of the annular projections (26), a recess or gap is created with respect to the tubular inner wall (14, 14′) of the housing, through which the polymeric fluid flows.

### DESCRIPTION OF THE INVENTION

The process of extracting liquid or gaseous hydrocarbons (HC) from the subsoil is carried out via the construction of wells with various technical requirements depending on the locality, whether it is a well on land or in the sea or lakes, the depth at which the resource is found, and the geological structure of the reservoir.

With the exception of the production of HC from oil sands, in the extraction of wells and depending on the pressure built up in the subsurface, the hydrocarbon initially flows to the surface once the geological formation is drilled and the rock is fractured in a process called “drilling”. Once the well declines in its “natural” production, the HC is extracted by pump via artificial lifting by gas (“gas lift”) as well as in the final stage, in which the usually significant quantities of hydrocarbon remaining in the reservoir must be extracted by means of enhanced recovery or secondary recovery techniques and procedures.

Secondary recovery consists of shifting the greater volume of hydrocarbons to the extraction well using the infrastructure already installed and involves the processes of injecting a carrier fluid, such as water, a gas, chemical compositions, or steam (among others) by means of additional injection wells.

Among these secondary recovery processes, one of the most common is the injection of water into the well. As is known, the external fluid (water or gas) is injected through the injection well in communication with the production wells, thus maintaining the reservoir pressure and displacing the hydrocarbons towards the production well for their extraction.

According to S. Q. Tunio, et al (Tunio, S. Q., Tunio, A. H., Ghirano, N. A., El Adawy, Z. M.) in “Comparison of Different Enhanced Oil Recovery Techniques for Better Oil Productivity,” (International Journal of Applied Science and Technology, vol. 1, no. 5, 2011, pp. 143-153), the enhanced recovery methods can be classified into two broad categories:
I. Methods that increase the volumetric sweep efficiency, and
II. Those that improve displacement efficiency.

Sweep problems can be solved by reservoir heterogeneity, while mobility or displacement can be controlled by controlling a fluid under pressure introduced into the reservoir.

This latter involves flooding the secondary borehole with polymer solutions or some other method of controlling HC mobility, such as thermal procedures. Moreover, capillary forces have a great impact on the hydrocarbon displacement process and is one of the forces responsible for sustaining the crude oil in the reservoir matrix. For this reason, and in order to reduce this action, chemicals, alkaline solutions, miscible gases, nitrogen and bacteria are used. The best option will also depend on several aspects; for example, in the case of polymeric fluids, what proportion should be injected into the formation, as well as how much of the polymer will be absorbed in the reservoir sands.

In addition to the above, R. Hinkley (“Polymer Enhanced Oil Recovery. Industrial Lessons Learned.” Oil & Gas Authority, October 2017) mentions that it has been proven that in reservoir waterflooding, water tends to form preferential paths in the formation, with water flowing in an arrow shape between injection wells and production wells, creating a conical upward flow pattern avoiding the zone where there are still large oil reserves, since all energy tends to dissipate along the path with minimum energy expenditure. This is improved by injecting water with high density polymers, which increases the homogeneous distribution of the fluid and increases the viscosity and therefore the resistance to flow with the consequent greater resource drag in the porous medium.

In the known techniques of water injection with high viscosity polymers, two major problems are recognized that determine limitations to their efficient use:
A. Polymer products dissolved in water (or dissolution medium) are usually expensive and are very sensitive to chemical, thermal, biological and mechanical degradation, conditions usually prevailing in the oil and gas extraction process. One of the major degradation factors of the polymeric chain is shear, since the stresses exerted on the polymeric molecules are usually of high magnitude and the polymeric chains tend to break because they do not withstand the conditions of mechanical forces imposed from the surface onto the fluid under injection, resulting in an irreversible loss of viscosity and flow resistance factor.
B. It is known that recent studies have produced advances in the efficiency of these polymers, giving them greater resistance to degradation up to the control of flow and pressure at the reservoir face to reduce the effects of capillarity and high flow obstruction. However, this flow and pressure control transfers the problem upstream. In effect, flow control regulators (valves and restrictions or registers and various forms of injection) use special stepping reduction valves. To date, localized flow and pressure drop control is determined at different injection well heights and at different geological layers, depending on the location of the reservoirs. However, this makes the control of the shear stresses of the polymeric molecules more complex and costly, even operationally burdensome, since nowadays it is usual to place pressure and flow control devices at each different height of the injection well, where the water flow regulating valves are located. Another additional problem is the limited space in the standardized pocket mandrels located at the various heights of the injection well where these devices must be housed, which is another severe limitation to the efficiency of these controls.

FIG. 1 shows a schematic and generic summary of a geological section of a water injection well known in the technique of wide application. In general terms, FIG. 1 shows that the well consists of a wellhead (1), the casing (2), the injection tubing (3), the pocket mandrels (4), the gaskets (5), the pressure and flow regulating valves (6), and the fluid outlet orifices from the casing to the reservoir are indicated with (7). In general terms, casing (2) as it is known, stabilizes the walls of the borehole, inside which are placed the mandrels (4) with their pockets arranged at the heights of the stratified reservoirs at various depths where the respective valves (6) are housed inside them. A pocket mandrel consists of a tube of oval or cylindrical cross section, with ends with eccentric reductions and standardized dimensions. In the inner side compartment of the mandrel, the cylindrical cross-section pocket is located. Inside the pocket is housed the flow regulating and injection valve of the HC drag solution. These pocket mandrels have different shapes and configurations, which are threaded to the tubing along its trajectory or length.

### TECHNICAL SECTOR

Production of liquid hydrocarbons through enhanced recovery processes (Enhanced Oil Recovery, EOR) as well as non-Newtonian fluid mechanics, mechanical degradation, and performance of polymeric solutions.

### PREVIOUS TECHNIQUE

Up to the previous sections, the generic framework within which the present invention is developed has been provided. Specifically analyzing the referenced valves, FIGS. 1-6, these are devices that mitigate the effect of the solicitations leading to degradation by polymeric chain breakage of said polymeric solutions, particularly the rate of strain in the main shear (“shear rate”) responsible for such a rupture of the polymer chain (Thomas, Antoine. “Polymer Flooding.” Chemical Enhanced Oil Recovery (CEOR): A Practical Overview, by Romero-Zerón Laura, InTech, 2016, Chapter 2, pp. 55-99).

In addition, references to the use of these devices to prevent the formation of emulsions due to polymer chain breakage can be found in Kwakernaak, Peter Jan, et al. (“Reduction of Oil Droplet Breakup in a Choke.” SPE One Petro, 2007, doi: 10.2118/106693-ms.) and A. S. Monteiro (2012).

In summary, and already specifically within the field of the present invention, the prior art recognizes the employment of valves capable of achieving a low rate of shear strain (“low sheer rate”) of polymers, which are flow-throttling valves used in order to:
Mitigate droplet breakup preventing the formation of emulsions; and.
Reduce the effects of mechanical degradation during the polymeric fluid injection process.

Mechanical degradation in secondary recovery processes by flooding the mandrel with polymer fluids occurs mainly during the injection of the fluid at the surface by controlling flow and pressure in the choke valves and when the fluid is introduced into the porous medium of the geological formation containing the HC. reserves. The high stresses to which these fluids are subjected by the small cavities and the capillarity effects force the use of different fluid outlet pressures for each geological formation, precisely to reduce as much as possible this degradation by shear.

With the currently available valve systems, it is technically complicated and extremely costly to achieve a differentiated injection pressure for each geological layer, to such an extent that such a solution is impractical in most cases. Below is a brief list of some of the patents that have attempted to solve this problem by means of various devices for this purpose.

It is known that, in most conventional pressure reducing valves, there is an energy balance through the transformation of pressure energy to kinetic energy, obeying the elementary laws of mechanics. This results in high velocity in the fluid field along with associated effects such as turbulence, acceleration and stress rates exerted on the polymeric fluid. The mixture of polymer and water is sensitive to these inertial forces, which cause the irreversible rupture of its molecules, losing the viscosity of the mixture and therefore its drag effectiveness when generating aqueous emulsions.

To that effect, U.S. Pat. No. 4,204,574 shows pressure control employing several separate pumps with their respective individual fluid streams.

U.S. Pat. No. 4,276,904 relates to a flow control device in a combination of helical tubes forming three coils. These coils are connected to a common flow distributor having a smaller diameter than the distributor.

Each of the coils with different internal tube diameters and with helical coiled of four (4) tubes and two (2) tubes. The flow control depending on the flow rate is performed with the operation of the number of open and closed valves. The fully open valves must be larger than the diameter of each tube and the nozzle connecting to the manifold. The internal diameters of the pipes ensure flow and pressure reduction with viscous degradation levels not exceeding 25%.

U.S. Pat. No. 4,617,991 shows a device that absorbs the energy of the fluid stream as do the blades of a hydraulic turbine in hydroelectric power stations. The concept is dynamic and low viscous degradation is achieved by moderate velocities in the flow field. It is compact enough to be installed on the surface at the wellhead, but not compact enough to be installed inside the tubing, let alone inside the pocket mandrels. In addition, the energy must be dissipated in some way, and for this it is required that these blades mobilize a heavy element or by means of a magnetic field, which would be the elements that finally transform the energy, exhibiting at high velocities the generation of shear strain that increases the percentages of viscous degradation.

U.S. Pat. No. 5,222,807 shows an apparatus for the mixing and dissolving of solid polymers in aqueous media at a low rate of shear strain, achieving high homogeneity of the mixture by means of continuous passage through a system of pipes, pumps and serial perforated plates held by chains that seeks the interlocking of the flow and thus the mixing.

U.S. Pat. No. 5,605,172 shows a conical swirl generator device. Its high volume makes it impossible for installation within the confined space provided by the pocket mandrel.

U.S. Pat. No. 8,770,228 relates to a set for a pressure and flow control valve by means of a conical chamber of tangential inlet and axial outlet. The flow enters in a rotary manner through the smaller section of the conical section to cause a velocity and pressure reduction effect due to the vortex effect. This device seeks to reduce shear strain effects in the fluid that can contribute to the breakup of droplets forming emulsions that are more complex to separate in oil production stations.

U.S. Pat. No. 9,260,937 shows a pressure reducing and flow control valve for injection of polymeric solutions directly into the formation in the injection tube. The main flow control element is constituted by a series of capillary tubes of different diameters placed in parallel inside a main tube that forms the valve. Depending on the desired operating conditions, each set can be configured by the number, dimension and positioning of the tubes. The claims filed in this application have three examples where they indicate viscous degradation levels between 20 and 36% for average pressure drop of 15 [bar]/218 [psi] at different tube configurations, lengths and flow rates.

The publication of Patent US 2017/0335655 A1 shows a low shear strain rate adjustable pressure and flow control valve for application in liquid hydrocarbon production processes. The device is composed of plates with a spiral channel that reduces the pressure via friction, and the form takes advantage of the greatest possible length in addition to the rotational effect of the geometry. The application of this device has the same functionality of the Typhonix U.S. Pat. No. 8,770,228, which seeks to reduce the effects of shear strain in the fluid to avoid the breakage of droplets that form emulsions that are more complex to separate in oil production stations and can affect downstream processes.

U.S. Pat. No. 10,024,128 B2 relates to one or more combinations of valves and internal pressure reducing elements at controlled shear strain and acceleration rates for secondary recovery processes and oil well servicing. About 65 internal pressure reducing devices via spiral channels, smoothing, screens, cross plates, swirlers, small cyclones, moving blades, filters, and perforated plates are disclosed, most with actuators to calibrate the desired flow and pressure.

If the valves of the prior art are not used, due to the disadvantages explained above, the known techniques try to solve the problem by resorting to alternatives such as:
By friction in the pipe in a flow regime in transition between laminar and turbulent flow, avoiding critical hydraulic diameters, and
By absorbing pressure energy through different forms of fluid rotation, which increases the trajectory and contact of the fluid and the surfaces of the cavity through which it flows, while at the same time taking advantage of all the possible volume of the valve, decreasing the pressure through the contraction of kinetic effects due to the rotation and friction of the polymeric fluid.

An example of the latter is the Argentine patent application P2019 01 01122 by the same applicants. Although this approach fulfills its purpose satisfactorily, the fluid can only decrease its pressure gradient by friction during the long helical path, so that there is a real limitation to the total pressure drop differential as a function of the developed volume of the helicoid, which in turn is imitated by the dimensions of the pocket.

According to L. Del Pozo et al. (2018) friction-only effects can be achieved at low shear strain rate by means of the aforementioned long extensions of helical paths, but it implies, apart from the aforementioned helicoid length limitation, also a high production cost.

A partial solution to this problem has been addressed in the publication, “PRACTICE AND UNDERSTANDING OF SEPARATE POLYMER INJECTION IN DAQING OILFIELD” by Liang Yaning & Zhang Shicheng, © Daqing Oilfield Comp. Ltd. Petrochina (SPE Production & Operations, vol. 26, no. 03, 2011, pp. 224-228, doi: 10.2118/128103-pa). This publication stipulates the use of longitudinal parts equipped with a plurality of annular protrusions axially arranged one after the other on the same longitudinal axis part. In theory and in computer model simulations, this solution works correctly by forcing the passage of the polymeric fluid through the successive restrictions existing between the wall of the pocket and the profile of said annular protrusions with the intermediate expansions between each adjacent pair of said protrusions.

However, in practice, this solution would be operationally complex to achieve since it is improbable that the longitudinal pieces with such protrusions would remain in a strictly fixed position respecting a predetermined separation between the profile of the protrusions and the inner surface of the pocket. Another drawback found with this intended solution to the problem posed is that such annular protrusions are inscribed inside an ideal cylinder, while the said cylindrical section (pocket) is not of a constant diameter along its length, which represents another problem for the protrusions if they are external. In addition, it is imperative to mention that, when using the pocket wall as a flow channeling element, it is inevitable that this part will be worn out due to erosion, thus reducing the mandrel's useful lifespan.

In fact, in order to effectively control the gradual pressure reduction on the polymeric fluid to avoid shear action and obtain the desired flow restriction, there must be a tolerance of ±0.05 mm constant between the separation of the annular profiles and the adjacent wall in order to achieve the phenomena that will be explained below and for the pressure decrease differential to be maintained. In practice, using the proposal made by Liang Yaning & Zhang Shicheng, this is not possible since in addition to the above-mentioned arguments, the phenomenon of vibrations inside the pipes must be added, which destroys all tolerance, and in short, the proposal as illustrated and explained in the aforementioned publication is not operationally achievable in practice. Moreover, the system of gaskets also influences this tolerance.

In addition to the above, an alternative solution to the problems described above has also been publicized in “SHEAR DEGRADATION MODEL OF HPAM SOLUTIONS DESIGN OF REGULATOR VALVES IN POLYMER FLOODING EOR” by F. A. Díaz, J. P. Torné, A. Prada, and G. Perez (Journal of Petroleum Exploration and Production Technology, vol. 10, no. 6, 2020, pp. 2587-2599, doi: 10.1007/s13202-020-00905-5). In this publication, two proposals are shown compact and installed inside regulating valves with standardized dimensions without the use of pocket walls, which is an advance over the proposal by Yaning & Zhang Shicheng, et al. (2011). They feature two devices, one with helical flow and the other with restrictions or shock orifices, emulating serial orifice plates. These researchers have reported achieving a differential pressure around 40 [Bar]/580 [psi], viscous degradations around 8.5 [%], and flow rate of 435 [Barrels/day]/69.1 [m³/d] from a helical flow device, while for the serial choke device they obtained 27 [Bar]/390 [psi] between 11 and 12 [%] viscous degradation, and flow rate of 560 [Barrels/day]/89 [m³/d]. They tested three concentrations of polymer solutions of 500, 700, and 1000 parts per million. However, the water hardness conditions in the preparation of the polymer were not reported, which could be an important variable in the viscous degradation. Accordingly, there is no evidence whether, for the experiment, it was carried out with distilled water at laboratory conditions or with dissolved salts, as is injected in the field, as the devices of the present invention were tested, which will be discussed in detail later on. Moreover, the quality of the polymer has also not been disclosed in this research.

### INVENTION DISCLOSURE

### Objectives of this Invention

It is the main objective of the present invention to minimize, within totally acceptable ranges, the mechanical degradation of polymeric fluids injected into porous and/or capillary geological strata in order to proceed to an efficient sweep and secondary recovery of hydrocarbons present in said geological formations, this by means of an effective control of the pressure decrease gradient applied to said sweep polymeric fluids.

It is the objective of the invention to reduce the pressure exerted on the polymeric solution flow within each range specifically required individually by each geological layer at a low viscous degradation rate of the polymeric fluid, independent of the wellhead injection pressure.

It is also the objective of the invention that this novel device be compact and capable of being housed within the standardized pockets of the mandrels of the infrastructure already installed in a well for the injection of water or aqueous solutions of polymeric fluids.

The objective of the invention is to achieve a preset and specific pressure graduation limitation for each case.

Another objective of the invention is to achieve a device that allows a calibrated pressure drop and, at the same time, is easy and simple to manufacture.

It is also an objective of the invention that the pressure reduction is achieved by employing static pressure reducing components fixed within the pocket mandrel without freedom of movement.

It is also the aim of the invention that, by applying a single wellhead pumping pressure of the polymeric solution, each device can be sized according to the depth of the pocket within which it is housed and the individual pressure drop required for each geological stratum.

### Summary of the Invention

This pressure and flow regulator for polymer injection is comprised of a wellhead (1) (FIG. 1) with the devices for pumping a carrier fluid; the casing (2) (FIG. 1), the injection pipe (3) (FIG. 1), and at least one pocket mandrel (4) (FIG. 1) linked to said injection pipe and in communication therewith, establishing an inlet communication of said fluid from the pocket mandrel to the injection pipe, and at least one fluid outlet from said injection pipe to the geological formation containing the hydrocarbon to be dragged by said dragging fluid, characterized in that it comprises a tubular piece defining a housing closed at both ends, whose respective external surface portions present means of fastening and linking to the inside of the pocket mandrel; internally the said housing has a tubular surface, and inside the housing there is a rod-shaped piece provided on at least part of its extension with a plurality of annular protrusions projecting perpendicular to its longitudinal axis, being defined between each pair of said annular projections, an annular recess; the upper end and the lower end of said rod-shaped part is retained by respective retaining means inside the corresponding ends of the housing; being defined between the back of said series of annular projections and the tubular inner surface of the housing, an annular gap <L6> with a range between 0.1 mm<L6<1.1 mm, preferably 0.2 mm<L6<1.0 mm, and more preferably still, L6 between 0.3 to 0.9 mm. The aforementioned housing has at least one inlet located adjacent to the upper end of the housing and below the retaining means of the rod-shaped part, communicating from the outside to the pocket mandrel with the inside of said annular gap, while adjacent to the lower end and above the retaining means of the rod to the inside of the housing, the same has at least one outlet opening, said inlets and outlets defining a passage of the polymeric solution through the inside of said annular gap. The height <L5> of the annular projections ranges from 0.7 mm<L5<1.1 mm, and the width <L4> of each annular projection ranges from 3 mm<L4<6 mm; the dimensions of <L4> and <L5> are considered from the primitive of the rod and the radius of curvature <r> of each annular rib ranges from 0.5 mm<r<1.5 mm. The separation or gap <L6> between the back of each rib and the interior of the housing has a range of 0.70<L6<0.45, being established during the passage of the polymeric solution over the back of each annular projection an acceleration of the flow velocity with a substantially laminar flow regime, followed by a deceleration into a substantially swirling flow, when said flow penetrates into the underlying annular recess.

### Detailed Description of the Invention

For the purpose of explaining the preferred embodiment examples of the present invention, the following drawings are attached to illustrate them, along with the support of the description of the same given below. These embodiment examples should be interpreted as one of the many possible constructions of the invention, for which reason no limiting value should be assigned to them, with possible means equivalent to those illustrated being included within the scope of the protection of the invention. The scope of this invention is determined by the first claim attached in the corresponding chapter of claims. Likewise, in these Figures, the same references identify equal and/or equivalent means.

In FIG. 2, the longitudinal cut to one of the possible constructions of the housing or tubular body generically indicated with (8) of the present invention is observed. Such housing (8) in one of the embodiments of the invention is formed by an upper tubular body (9) which axially links with a lower tubular body (10). The reason why said housing (8) is formed by the coaxial union of two tubular sections is due to machining reasons; additionally, if desired, it allows for varying the fluid-dynamic conditions of the polymeric solution when passing from the upper section to the lower section, but nothing prevents this housing (8) from being machined in a single tubular piece.

The upper end of the section (9) is closed by a top cover (11), which features internally and coaxially a housing (12) which opens downwards, i.e., facing the tubular interior (14). Below this housing, the upper section (9) has at least one opening that defines a communicating passage (13) on the outside with the inside (14, 14′) of the tubular housing (8). The lower end of (8) is closed by a piece (15) known as the “nose”, which internally and coaxial to the axis of (8) has a housing (16) directed upwards, i.e., towards the inside of (14′). This nose (15) has a communicating outlet (17) connecting the inside (14, 14′) of (8) with the outside, and above this outlet orifice, there is a gasket (15′).

With respect to the dimensions of the housing (8), they may have the following range, although these values are given as a non-limiting example only:
Length <L2> of the upper section (9): 250<L2<252 (mm);
Length <L3> of the lower section (10): 300<L3<305 (mm);
Total length <L1> of housing (8) between ends: 555.70 (mm);
Internal diameter <r1> of (14): 30<r1<31 (mm);
Internal diameter <r2> of (14′): 22<r2<25 (mm);

FIG. 4 shows a perspective of one of the possible constructions of the rod-shaped part, generically indicated with the reference (18). This rod is elongated, and in the particular illustrated case, it is formed by two axially aligned sections (20, 21). In each section (20, 21) there is a variety of annular projections (26) (see FIGS. 6, 7, 8, and 9) that project perpendicular to the longitudinal axis of the piece (18). Between each pair of annular projections, a depression (27), also annular, is formed, resulting in each projection (26) spaced and separated by said annular recess or depression (27), forming along each rod section (20, 21) a continuous and wavy surface whose cross section (FIGS. 7a, 7b, 8) represents a sinusoid. This rod is completed with an upper end (19) and a lower end (22).

FIG. 6 illustrates the assembly of the rod (18) inside the housing (8), according to FIG. 2, showing the rod body with the annular projections of FIGS. 4 and 5 installed inside the housing. As already mentioned, these figures only serve to give an idea of the set. The shapes of the annular projections (26), of the annular intermediate depressions (27), and of the gap between the inner wall (14, 14′) with respect to the back of the annular projections, with their respective dimensions and the operation of the present invention, are detailed from the following figures.

FIGS. 7a and 7b illustrate portions in a very extended longitudinal cut of a preferred construction of the annular projections (26) and their intermediate annular recesses (27), showing respectively for the upper and the lower section the following ranges of dimensional values. Considering that the rod (18) is a cylindrical piece on which the mentioned ribs (26) with their respective annular depressions (27) are machined, consequently the bottom of the “valley” of each depression can be considered as the primitive for the purposes of the following measurements, given by way of example:
The height <L5> of the annular projections ranges from 0.7 mm<L5<1.1 mm measured from this primitive (see FIG. 7b);
The width <L4> of each annular projection, measured above the primitive on both sides of the rib, has a range of 3 mm<L4<6 mm;
The curvature radius <r> of each annular rib is between 0.5 mm<r<1.2 mm;
The recess or gap <L6> between the back of each rib (26) and the inside (14) of the housing (8) facing the back of each rib has a range 0.70<L6<0.45.

In addition, always in accordance with the embodiment illustrated in FIGS. 4 and 6 by way of a non-limiting example of the rod (18) with ribs (26), this rod is composed of two axially assembled sections and features in its upper section (20) a number of 52 annular depressions (27), i.e., 53 annular projections, while in the lower portion (21), it features 47 annular depressions with 48 annular projections. The latter data are given merely as a non-limiting example of one of the possible embodiments of the invention.

FIG. 8 shows (very enlarged) the transition of a first upper section (20) with a second lower section (21) of the rod body (18). In this figure, the axial splice of both ribbed rod sections and the reduction of the diameter of the second lower section (21) with respect to the upper section (20) can be observed. It can be inferred empirically and by way of educated hypothesis that, notably, the second section (21) presents a slightly different thermodynamic behavior than the upper section, caused by the reductions in diameter, by a slightly different clearance <L6>, and by having a different number of ribs. Not to forget that the chamber (28) obtained by the flaring (23) in the transition between both sections of the rod (18) presents a center of fluid accumulation.

FIG. 9 illustrates the result of a simulation under computational fluid dynamics for a flow rate of 555 [barrels/d]. The circular sections simulate the backs of the ribs (26), and the relatively laminar flow against the housing wall (8) is noted. Vortex generation (V1) is demonstrated with possible bubble detachment due to the sudden reduction of the fluid vapor tension, i.e., reduced zones of partial cavitation are created. The reference (V2) is the zone of large vortices and low pressure, and (V3) is the laminar flow zone adjacent to the wall (14, 14′).

The examples illustrated for both the housing (8) and the rod (18) are, of course, merely examples of construction. There is nothing to prevent the use of single-piece rods, with or without the reduction between the upper and lower sections, nor is there anything to prevent modification of the radii of curvatures of the backs and the depressions of the projections (26, 27), respectively. There is no transition from the upper to lower rings. The transition is only a result of geometrical limitations due to the space available inside the valve.

### Theoretical Considerations Relating to the Operation of the Present Invention

The purpose of the present invention is to obtain benefits from a phenomenon known as vortex shedding, which is usually a negative in other industrial equipment such as, for example, heat exchangers and slide valves. In the case of this pressure reducer, this phenomenon can be used as an energy dissipator with low incidence on the polymer, mitigating viscous degradation and obtaining higher differential pressure. The fluid moves adjacent to the inner wall of the valve above the ribs and with turbulent flow in the depressions between ribs, and a part of the flow passes over the annular ribs away from the annular depressions or grooves; i.e., it travels parallel to the inner wall of the valve in annular flow.

As already mentioned, the projecting annular ribs perpendicular to the rod axis (18) form an annular flow, formed between the outer diameter of the rod and the inner wall of the valve.

The hypothesis of this system is based on achieving high energy dissipation by the “compression and expansion” of the fluid through the ribs with the intermediate depressions due to the changes in cross-sectional area of the annulus in each depression, and consequently, changes in velocity. In addition, the number of grooves also affects the differential pressure. In terms of chemical advantages, this system of ribs/depressions decreases the effect of molecule rupture by making the pressure drop in a staggered manner, which subjects the fluid to high shear, but only in small fractions of time. This does not happen in the flow through propeller coils or other pressure control devices to the same effect. According to the present invention, the time to which the fluid is subjected to conditions of rupture of the molecules must be extremely limited, avoid constant shearing, and spend as little time as possible subjected to high stresses and deformation, which are conditions responsible for the mechanical degradation of these polymeric materials.

The equation governing the strain rate in shear is:

$$\dot{γ} = \frac{d u}{d r} [ 1 / s ] \qquad ( 1 )$$

Where (d/u) is the velocity differential and (d/r) is the equivalent hydraulic diameter differential.

### BRIEF DESCRIPTION OF FIGURES

FIG. 1 shows a schematic and generic summary of a geological cross-section of a water injection, a well-known technique;

FIG. 2 shows, in a longitudinal section, one of the possible constructions of the housing or tubular body;

FIG. 3 shows an external view of the tubular body or housing;

FIG. 4 shows the rod body in perspective and isolated from the housing;

FIG. 5 shows the rod body in front view and isolated from the housing;

FIG. 6 illustrates the longitudinal cut of one of the possible embodiments of the invention, showing the rod body with the annular projections of FIGS. 4 and 5 installed inside said housing according to FIG. 2;

FIGS. 7a and 7b illustrate very enlarged longitudinal cut portions of a preferred construction of the annular protrusions, showing for the upper and the lower sections respectively the dimensional values of the same as well as their clearance with respect to the inner tubular wall of the housing;

FIG. 8 shows the transition from a first upper section to a second lower section of the rod body in a much-enlarged form;

FIG. 9 illustrates a computational fluid-dynamic simulation of the flow passage through the ribs and annular depressions, illustrating the transition from laminar flow to a turbulent (or transient) flow regime for each passage through the gap between ribs and housing; and

FIG. 10 shows the computational shear results compared with the viscous degradation and differential pressure data of three experimentally tested prototypes.

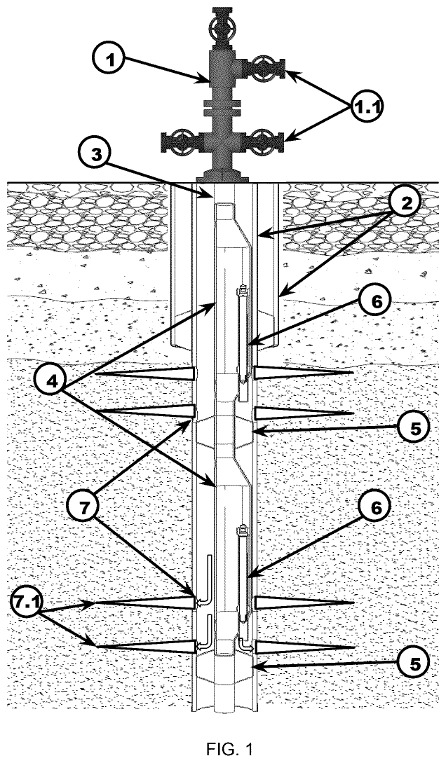

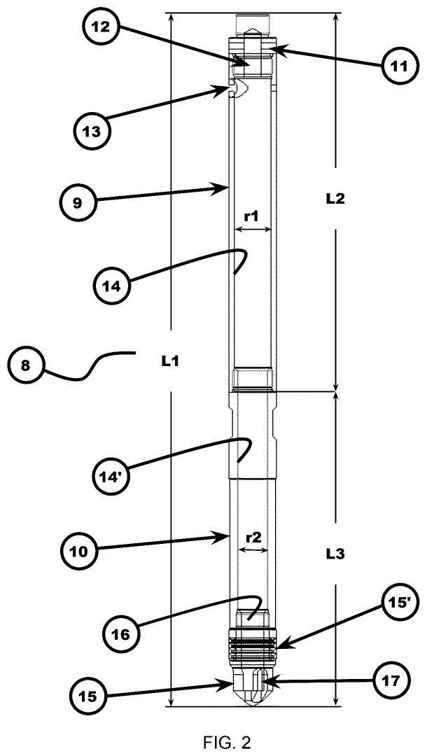

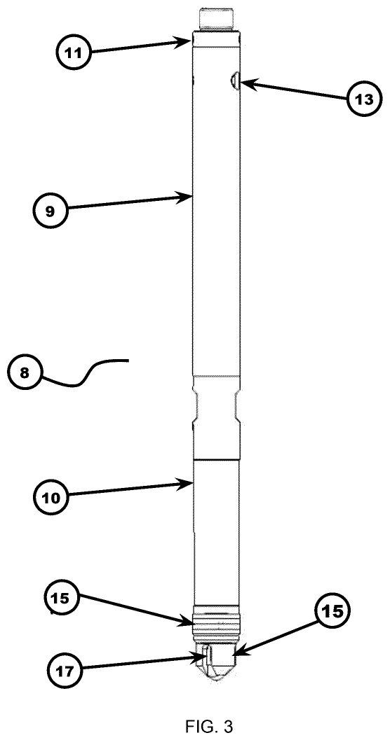

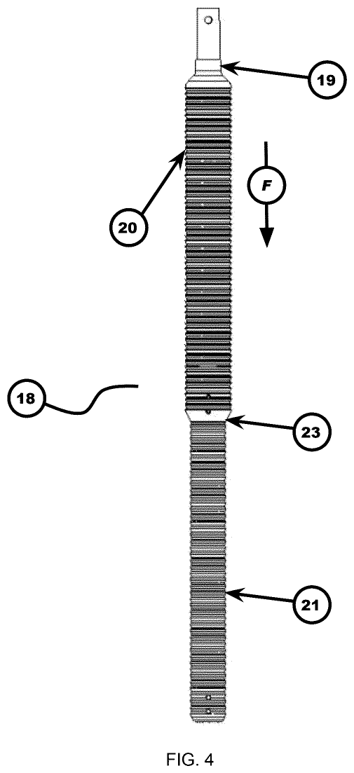

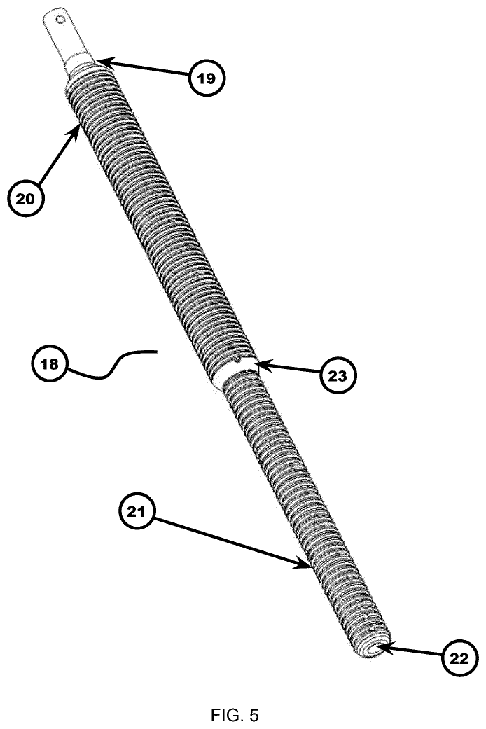

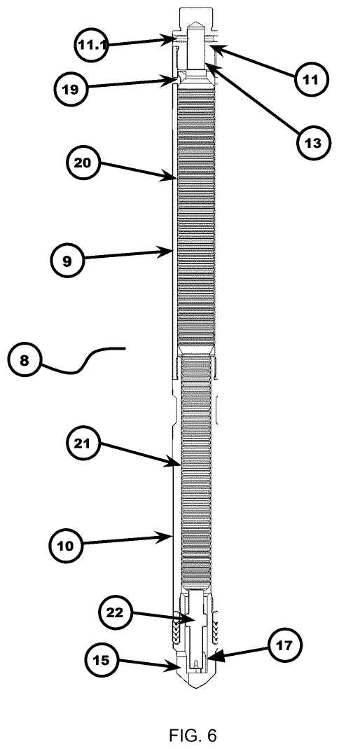

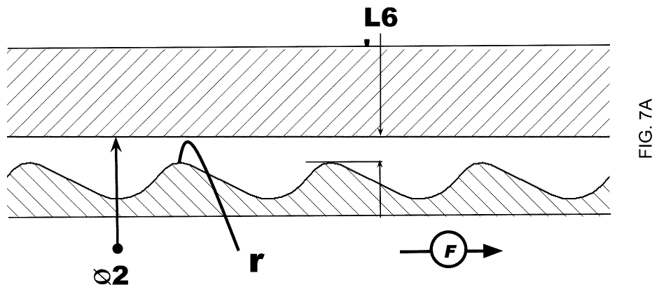

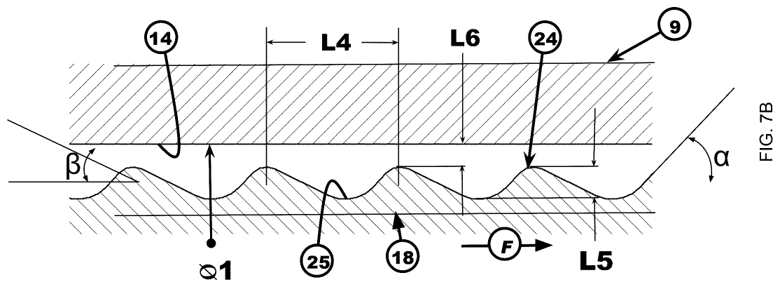

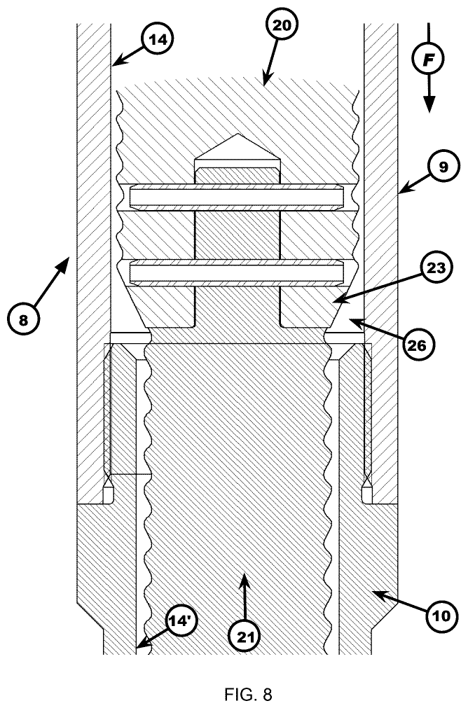

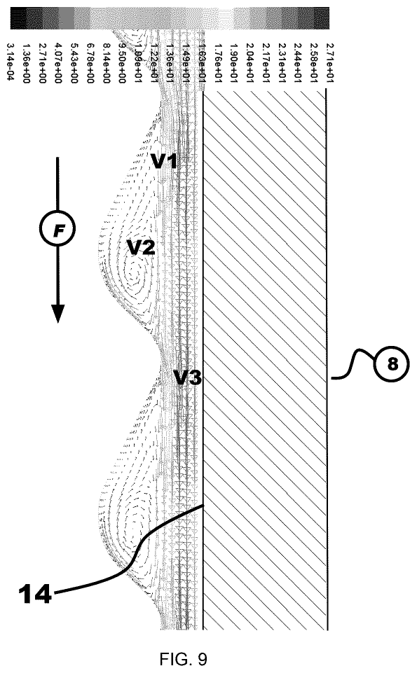

### EXAMPLES

The following examples are presented without limitation on the scope of this invention:

In total there are two experimental examples and one computational example showing the main variables that affect the mechanical degradation of polymers, such as the shear rate, as well as the validation of the computational calculations with the experimental data.

Experimental data were obtained from a pilot test rig, which is a platform that is easily mobile to any location where there is an oilfield polymer injection operation. This system is mainly composed of a standard 38.1 [mm]/1.5 [in] pocket housing, a diaphragm type positive displacement pump with a maximum capacity of 245 [m³/d] and maximum pressure of 241 [Bar]; 4 tanks for the system supply (three main tanks and one reserve tank) with a total capacity of 4901 [liters], two pressure transmitters located upstream just before the housing inlet and one downstream of the housing, a pressure transmitter for the safety system calibrated to shut down the system at 213 [Bar], and two bourdon type pressure gauges to have analogous readings; and two relief valves, one located at the pump outlet, and one in the tank system.

In addition, two throttling valves are provided, one that separates the high-pressure zone from the low-pressure zone, and one that is used to restrict the flow and raise the operating pressure of the housing to 206.8 [Bar]. Finally, the rig has two sampling points upstream and downstream from the housing in order to take the polymer without valve effect and after valve effect, respectively. All signals of interest are recorded on a video-graphic data acquisition system.

The viscous degradation is obtained by equation 2, which has also been used by Naug, S, and J Mari (“Improvement in Polymer Waterflooding Efficiency Using a Low Shear Choke Valve.” [MS Thesis] University of Stavanger, 2013).

$$\% Degradation = \frac{{η}_{0} - {η}_{d e g}}{{η}_{0} - {η}_{{H}_{2} O}} \times 100 \qquad ( 2 )$$

where,
η₀=Viscosity of the solution “without degradation”
η_{deg}=Viscosity of the solution “with degradation”
η_{H}_{₂}_{O}=Water viscosity (0.59 cP a 45.5° C.)

### Example 1

Experimental tests have been carried out with identical geometries of the projecting ribs, both the upper and lower rod, as well as maintaining an equivalent annular area to ensure the same flow velocity at the top and bottom, thus maintaining a constant shear strain rate.

For this example, a solution of hydrolyzed polyacrylamide (HPAM) Floppam 3230S by SNF at concentrations of 600 and 700 mg/l was used. The tests were performed at high flow 89 [m³/d]/560 [bbl/d] and valve inlet operating pressure of 206.8 [Bar]/3000 [psi]. Additionally, tests were performed on mean flow of 44.5 [m³/d]/280 [bbl/d] and also valve inlet operating pressure of 206.8 [Bar]/3000 [psi].

Table 1 shows the results obtained from these experimental tests, operational conditions and physical characteristics of the fluids for the prototype called “Annular-A”.

TABLE 1
Experimental Results of “Annular -A-” Device

| Tests | SNF-3230S | SNF-3230S | SNF-3230S | SNF-3230S |
|---|---|---|---|---|
| Solution viscosity [cP] | 9.8 | 18 | 11.0 | 13.7 |
| “Without degradation” | | | | |
| Solution viscosity [cP] | 7.2 | 14 | 10.0 | 13.0 |
| “With degradation” | | | | |
| Concentration of | 600 | 700 | 600 | 700 |
| polymers in solution | | | | |
| [ppm] | | | | |
| Flow rate [bbl/d]/[m³/d] | 554.4/88.7 | 555/89.4 | 285/44.5 | 280/44.5 |
| Differential pressure | 562/38.7 | 609 | 172/11.8 | 172/11.8 |
| [psi]/[Bar] | | | | |
| Degradation [%] | 28.23 | 22.98 | 9.61 | 5.34 |

### Example 2

With this experiment, the performance of a valve with the lower rod with a distinct geometrical configuration is evaluated: specifically, the distinct distance between the crests of the projections with respect to the first section or upper rod. In addition, the hydraulic diameter of the annular cavity is modified, which allows for decreasing the flow velocity in the lower rod and, consequently, the shear strain rate from higher (upper rod) to lower (lower rod).

For this example, two types of polymer solutions were used, hydrolyzed polyacrylamide (HPAM) Floppam 3230S by SNF (600 and 700 mg/l concentration) and a surfactant-stabilized hydrolyzed polyacrylamide solution EOR-880 by NALCO (700 [mg/l] concentration). The tests were performed at high flow 89 [m³/d]/560 [bbl/d] and valve inlet operating pressure of 206.8 [Bar]/3000 [psi]. Additionally, tests were conducted at an average flow rate of 44.5 [m³/d]/280 [bbl/d] and also at an inlet operating pressure of 206.8 [Bar]/3000 [psi].

Table 2 shows the results obtained from these experimental tests, operational conditions and physical characteristics of the fluids for the prototype called “Annular —B—”.

TABLE 2
Experimental Results of “Annular -B-” Device

| | | SNF-3230S | | | |
|---|---|---|---|---|---|
| Tests | SNF-3230S | (Duplicated) | SNF-3230S | NALCO-EOR880 | SNF-3230S |
| Solution viscosity [cP] | 17.6 | 19.8 | 16.3 | 23.6 | 13.30 |
| “Without degradation” | | | | | |
| Solution viscosity [cP] | 15.6 | 17.9 | 15 | 21.5 | 13.0 |
| “With degradation” | | | | | |
| Concentration of | 700 | 700 | 600 | 700 | 700 |
| polymers in solution | | | | | |
| [ppm] | | | | | |
| Flow rate | 559.2/89.4 | 550/88 | 549.6/87.9 | 560/89.6 | 285/45.6 |
| [bbl/d]/[m³/d] | | | | | |
| Differential pressure | 558/38.5 | 545/37.6 | 551/38 | 488/33.6 | 172/11.8 |
| [psi]/[Bar] | | | | | |
| Degradation [%] | 11.7 | 9.8 | 8.2 | 9.1 | 2.3 |

During all the tests, three water hardness samples were taken approximately every nine tests, resulting in 80, 92, and 115 [ppm] concentration. This shows that the test conditions were field conditions and not laboratory conditions. The water was not treated by plants for hardness reduction or stabilization, an important parameter in the viscous degradation of the fluid.

### Example 3

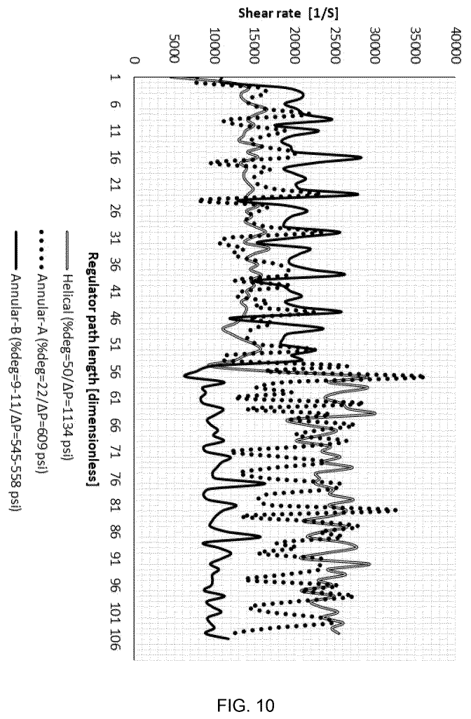

FIG. 10 shows the results of a computational simulation demonstrating the scaled shear concept. According to the prior art, an acceptable shear value to avoid viscous degradation should be below 10,000 [1/s]; while 18,000 [1/s] is categorized as critical. Whereas, above 18,000 [1/s], it is completely adverse. The graph shows for a device in helical flow at a constant shear rate between 15,000 and 29,000 [1/s], while annular flow (A) through grooves records peaks between 13,000 and 28,000 [1/s] at the upper reducer and between 11,000 and 36,000 at the lower reducer. However, shear decreases markedly in the annular flow (B) through grooves, of which between 8,000 and 16,000 is recorded in the lower reducer. The intermittent shear has established viscosity losses according to the tables of examples 1 and 2, between 22 and 28 [%] for annular device (A); and between 8 and 12 [%] for annular (B); while for helicoidal flow, viscosity losses between 40 and 50 [%] were recorded. This, at maximum operating flow rate, is the most critical condition, according to theory.

Finally, the differential pressure results were compared between the experimental and computational results, which are presented in Table 3.

TABLE 3
Validation of Computational Results with Experimental Data

| Valves | Helicoidal | Annular -A- | Annular -B- | Annular -A- | Annular -B- |
|---|---|---|---|---|---|
| Differential | 1196.2/82.4 | 558.9/38.5 | 525.2/38.2 | 186.2/ | 186.2/ |
| pressure | | | | | |
| [psi]/[Bar] | | | | | |
| Computational | | | | | |
| simulation (CFD) | | | | | |
| Flow rate | 580/92.8 | 555/88.8 | 555/88.8 | 280/44.5 | 280/44.5 |
| [bbl/d]/[m³/d] | | | | | |
| Computational | | | | | |
| simulation (CFD) | | | | | |
| Differential | 1134/78.2 | 609/38.7 | 558/38.5 | 172/11.8 | 172/11.8 |
| pressure | | | | | |
| [psi]/[Bar] | | | | | |
| Experimental | | | | | |
| Flow rate | 580/92.8 | 555/88.8 | 559.2/89.4 | 280/44.5 | 285/45.6 |
| [bbl/d]/[m³/d] | | | | | |
| Experimental | | | | | |
| Relative error [%] | 5.58 | 8.22 | 5.87 | 8.27 | 8.27 |

The same FIG. 10 shows the results of shear strain rate through the internal system of the valve with flow rate of about 555 [bbl/d] using Floppam 3230S material at 700 [ppm]; implementing the power law model for a non-Newtonian fluid is expressed by equation 3.

$$η = K ( {\dot{γ}}^{n - 1} ) \qquad ( 3 )$$

where
η=Viscosity relative to shear stress
K=Coefficient given by the polymer curve
n=The behavior of the fluid under shearing

One of the parameters to which the chain-breaking effects of polymer molecules is attributed are the shear stresses in the flow—specifically, the shear rate. Although the ideal would be to reduce this value to the minimum possible, the reality of the mechanical energy balance becomes a difficult objective to achieve, considering the differential pressure to be reached in the limited space of a pocket valve-pocket mandrel system. However, the computational results show the different average shear rate levels along the valve, which, when compared with the experimental data, make it possible to observe interesting results that delimit the behavior.

FIG. 10 shows the shear rate curves obtained via computational fluid-dynamic simulation of the helical flow prototype from previous tests and the “Annular —A—” and “Annular —B—” prototypes equipped with different annular rib configurations. From the computational results, it is mainly observed how, even with a very similar shear rate magnitude between the helical and annular —A— models, the annular —A— model practically obtained a decrease of the shear effects to less than half that of the helical model in terms of degradation. However, this is also with a decrease in differential pressure, a decrease which does not significantly affect the scope and objectives of the present invention. In addition, the most interesting aspect is the behavior of the “Annular —B—” model, where a remarkable decrease in the shear in the lower rod was obtained, which significantly decreased the percentage of viscous degradation. This validates the design strategy of the interiors of the “Annular A and B” models, even more the “Annular —B” model, which achieved an important part of the anticipated expectations for this geometry.

In addition, the “Annular A and B” prototype improves the shrinkage conditions at the inlet to the reducer device, which mitigates possible shear stress concentration points on the fluid that can negatively influence the performance of the valves.

One particular construction (not illustrated) contemplates that between pairs of annular projections, a buffer space is created comprising a substantially cylindrical rod section, creating accumulation chambers along the fluid path.

1. (canceled)

2. (canceled)

3. (canceled)

4. (canceled)

5. (canceled)

6. (canceled)

7. (canceled)

8. (canceled)

9. (canceled)

10. A pressure regulator for polymer injection, comprising:
A) a wellhead (1) having devices (1.1) for pumping a carrier fluid;
B) a casing (2),
C) an injection tubing (3), and
D) at least one pocket mandrel (4) connected to said injection tubing and in communication with the same, defining an inlet communication for said fluid from the injection tubing (3) to the pocket mandrel (4); and further including at least one fluid outlet (7.1) from said pocket mandrel (4) to a geological formation containing hydrocarbon to be dragged by said drag (7.1) fluid, characterized in that it comprises a tubular piece (8) defining a housing (8) having two closed ends (11; 15) with respective external surface portions each, present means of fastening (15′) and connected to the interior of the pocket mandrel (4), and said housing (8) further including a tubular surface (14; 14′), and inside the housing (8) having a rod-shaped piece (18) with at least part of its extension having a plurality of annular projections (24) projecting perpendicular to the longitudinal axis of rod-shaped piece (18), with an annular recess (25) defined between each pair of said annular projections (24); the upper end and the lower end of the said rod-shaped piece (18) is retained by respective retaining means (11.1) to the inside of the corresponding closed ends (11; 15) of the housing (8), the back of said series of annular projections (24), and the tubular inner surface (14; 14′) of the housing (8), defining an annular gap (L6 and L6′) with a range between 0.4 mm and 1.1 mm; the said housing (8) has at least one inlet (13) located near the upper end of the housing (8) and below the retaining means of the rod-shaped piece (18), communicating from the outside to the pocket mandrel (4) with the inside of the said annular gap (L6 and L6′), while near the lower end and above the retaining means of the rod to the inside of the housing (8), it has at least one outlet opening, with these inlets and outlets defining a passage of a polymeric solution through the inside of the said annular gap (L6 and L6′); the height of the annular projections ranges from 0.7 mm<L5<1.1 mm, and the width <L4> of each annular projection has a range between 3.5 mm and 4.5 mm, with the dimensions of the width of the annular projections <L4> and the height of the annular projections <L5> being considered from the bottom of the annular recess “25” and the radius <r> of each annular rib (24) having a range between 0.5 mm and 1.2 mm; the gap (L6; L6′) between the backside of each rib (24) and the inside of the housing (8) having a range between 0.70 and 0.45 mm., establishing an acceleration of the flow velocity in a substantially laminar flow regime during the passage of the polymeric solution over the backside of each annular projection, followed by a deceleration into a substantially swirling flow as the flow penetrates the underlying annular recess.

11. The pressure regulating device as claimed in 1, characterized in that the tubular piece defining the housing has a cylindrical interior (14, 14′).

12. The pressure regulating device, as claimed in 1, characterized in that the rod-shaped part has two independently machined and axially linked sections, the upper one has a larger diameter than the lower portion of said rod, with the annular projections being circular in shape.

13. The pressure regulating device, as claimed in 1, characterized in that the rod-shaped piece is a single piece, with the annular projections being circular in shape.

14. The pressure regulating device, as claimed in 1, characterized in that the annular gap <L6> has a tolerance of ±0.05 mm constant in its dimensions between the separation of the annular profiles and the adjacent wall of the housing.

15. The pressure regulating device, in accordance with claims from 1 to 5, characterized in that the annular projections are parallel to each other and arranged to a continuation of each other with an annular depression of separation between two adjacent annular projections.

16. The pressure regulating device, in accordance with claims from 1 to 5, characterized in that the annular projections are parallel to each other, and at least some of the pairs of adjacent annular projections are separated by a substantially cylindrical section in depression.

17. The pressure regulating device, in accordance with claims from 1 to 7, characterized in that the profile of each of the annular projections has a rounded cross-section.

18. The pressure regulating device, in accordance with claims from 1 to 8, characterized in that the profile of each of the annular projections and of the annular depressions forms a sinusoid in longitudinal cut.
